(19) United States
(12) Patent Application Publication
(10) Pub. No.: US 2015/0079963 A1
(43) Pub. Date: Mar. 19, 2015

(54) METHOD AND DEVICE FOR DISPLAYING NOTICE INFORMATION

(71) Applicant: Xiaomi Inc., Beijing (CN)

(72) Inventors: Peng SUN, Beijing (CN); Wenlin Wang, Beijing (CN); Weixing Li, Beijing (CN)

(73) Assignee: Xiaomi Inc.

(21) Appl. No.: 14/452,766

(22) Filed: Aug. 6, 2014

Related U.S. Application Data
(63) Continuation of application No. PCT/CN2014/077005, filed on May 8, 2014.

(30) Foreign Application Priority Data
Sep. 17, 2013 (CN) 201310424863.7

(51) Int. Cl. H04M 1/725; G06F 3/0483; G06F 3/0484; H04W 4/00

(52) U.S. Cl. CPC H04M 1/72597; H04W 4/003; G06F 3/0483; G06F 3/04842
USPC 455/418; 455/566

(57) ABSTRACT

A method for an electronic device to display notice information, includes: receiving notice information sent from an application program, the received notice information including one or more operation elements provided by the application program; and displaying, on a display of the electronic device, the received notice information in a predetermined area, the predetermined area being at least one of an area displaying a status bar or an area adjacent to the status bar, the status bar being arranged along an edge of the display.

### CROSS REFERENCE TO RELATED APPLICATION

This application is a Continuation of International Application No. PCT/CN2014/077005, filed May 8, 2014, which claims priority from Chinese Patent Application No. 201310424863.7, filed Sep. 17, 2013, the entire content of all of which is incorporated herein by reference.

### TECHNICAL FIELD

The application generally relates to the field of computer technology and, more particularly, to a method and a device for displaying notice information.

### BACKGROUND

When an application program generates notice information in an electronic device, such as a new message notice or a new call notice, etc., the notice information is displayed on a display of the electronic device for a user to check and manage the notice information.

A conventional method for displaying the notice information includes, after receiving the notice information, displaying a prompt box corresponding to the notice information with a highest priority on the middle of the display of the electronic device. As a result, the user may firstly need to handle content in the prompt box or close the prompt box before the user can carry out other operations.

For example, the electronic device may be a mobile phone. If the user receives a telephone call when the user is performing an operation on the mobile phone, such as sending a text message, a prompt interface of the call will interrupt the user's operation and generally occupy a whole display of the mobile phone. The user needs to answer the call, or reject the call, or wait until the caller hangs up before the user can continue the original operation. Also for example, when the user is playing a computer game or browsing a webpage, a prompt box corresponding to the notice information may jump into the middle of the display. To continue to playing the computer game or browsing the webpage, the user may need to handle content in the prompt box or close the prompt box firstly, which may affect the user's current operations.

### SUMMARY

According to a first aspect of the present disclosure, there is provided a method for an electronic device to display notice information, comprising: receiving notice information sent from an application program, the received notice information including one or more operation elements provided by the application program; and displaying, on a display of the electronic device, the received notice information in a predetermined area, the predetermined area being at least one of an area displaying a status bar or an area adjacent to the status bar, the status bar being arranged along an edge of the display.

According to a second aspect of the present disclosure, there is provided an electronic device, comprising: a processor; a display; and a memory for storing instructions executable by the processor; wherein the processor is configured to: receive notice information sent from an application program, the received notice information including one or more operation elements provided by the application program; and display the received notice information in a predetermined area, the predetermined area being at least one of an area displaying a status bar or an area adjacent to the status bar, the status bar being arranged along an edge of the display.

According to a third aspect of the present disclosure, there is provided a non-transitory storage medium having stored therein instructions that, when executed by a processor of an electronic device, cause the electronic device to perform a method for displaying notice information, the method comprising: receiving notice information sent from an application program, the received notice information including one or more operation elements provided by the application program; and displaying, on a display of the electronic device, the received notice information in a predetermined area, the predetermined area being at least one of an area displaying a status bar or an area adjacent to the status bar, the status bar being arranged along an edge of the display.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for displaying notice information, according to an exemplary embodiment.

FIG. 2 is a flowchart of a method for displaying notice information, according to an exemplary embodiment.

FIG. 3A is a view of a display including a predetermined area adjacent to a status bar, according to an exemplary embodiment.

FIG. 3B is a view of a display including an area displaying a status bar as a predetermined area, according to an exemplary embodiment.

FIG. 4A is a view of a display in enlarging notice information, according to an exemplary embodiment.

FIG. 4B is a view of a display in enlarging notice information, according to an exemplary embodiment.

FIG. 4C is a view of a display in unfolding notice information, according to an exemplary embodiment.

FIG. 5 is a view of a display in hiding displayed notice information, according to an exemplary embodiment.

FIG. 6 is a flowchart of a method for displaying notice information, according to an exemplary embodiment.

FIG. 7 is a view of a display displaying a plurality of pieces of notice information on a current display page in a predetermined area, according to an exemplary embodiment.

FIG. 8A is a view of a display in turning a current display page to a next page in a predetermined area, according to an exemplary embodiment.

FIG. 8B is a view of a display in turning a current display page to a next page in a predetermined area, according to an exemplary embodiment.

FIG. 8C is a view of a display in turning a current display page to a previous display page in a predetermined area, according to an exemplary embodiment.

FIG. 8D is a view of a display in turning a current display page to a previous display page in a predetermined area, according to an exemplary embodiment.

FIG. 9 is a block diagram of an apparatus for displaying notice information, according to an exemplary embodiment.

FIG. 10 is a block diagram of an apparatus for displaying notice information, according to an exemplary embodiment.

FIG. 11 is a block diagram of an electronic device, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

In the present disclosure, an electronic device can be, but is not limited to, a smart phone, a tablet computer, a personal digital assistant (PDA), an intelligent TV, an E-book reader, a moving picture experts group audio layer III (MP3) player, a moving picture experts group audio layer IV (MP4) player, a notebook, or a personal computer.

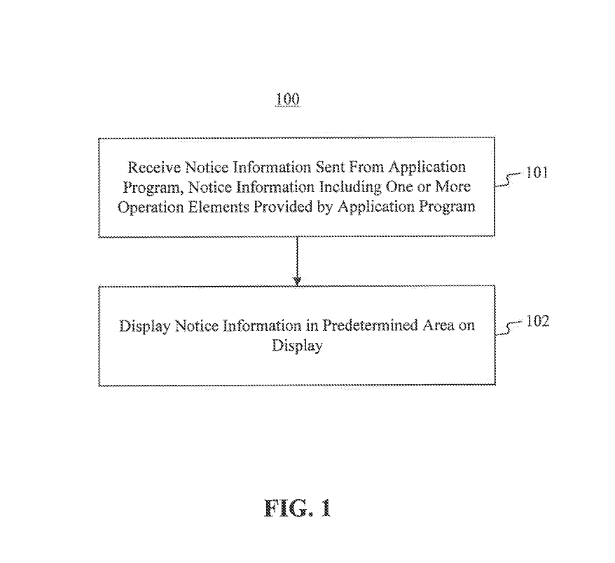

FIG. 1 is a flowchart of a method 100 for an electronic device to display notice information, according to an exemplary embodiment. Referring to FIG. 1, the method 100 can comprise the following steps.

In step 101, the electronic device receives notice information sent from an application program, the notice information including one or more operation elements provided by the application program. For example, the operation elements may include a selection button and/or a text input box. Also for example, the application program may be an application program installed in the electronic device, such as an application program for telephone communication, an application program for receiving and sending messages, an address book, a notepad, a browser, and the like.

In exemplary embodiments, the notice information is information generated by the application program to notice a user. The notice information can include a text message used to inform the user regarding certain information. In addition, when the user needs to perform an operation after checking the text message, the application program can designate one or more operation elements in the sent notice information, such as a selection button and/or a text input box provided for the user's operations.

In step 102, the electronic device displays the notice information in a predetermined area on a display. For example, the predetermined area is an area displayed in a status bar, or an area adjacent to the status bar.

In exemplary embodiments, the status bar displayed on the electronic device may be arranged along an edge of the display. For instance, the status bar can be arranged along the top edge, the bottom edge, the left side edge, or the right side edge of the display. The status bar can display current statuses of application programs, such as a battery power status, a system time, a wireless signal reception status, etc. Moreover, the status bar can display icons representing the generation of notice information by the application programs and corresponding to the application programs.

In exemplary embodiments, the predetermined area can be a rectangular area that is adjacent to the status bar in parallel. The predetermined area can also be a rectangular area displaying the status bar. The predetermined area can also be of other shape, such as an ellipse, a polygon, etc.

In one exemplary embodiment, the method 100 may further include receiving operation information generated when an operation element displayed in the notice information is operated, and sending the operation information to the application program for processing. The application program to implement a process according to the received operation information.

In one exemplary embodiment, the method 100 may further include deleting the displayed notice information after receiving the operation information generated when the operation element displayed in the notice information is operated.

In one exemplary embodiment, the method 100 may further include receiving an unfolding instruction generated when implementing an unfolding operation for the displayed notice information, and displaying the unfolded notice information after receiving the unfolding instruction.

In one exemplary embodiment, the method 100 may further include receiving a hiding instruction generated when an operating position is not located in the predetermined area, and hiding the notice information that has been displayed.

In one exemplary embodiment, when the predetermined area is the area displaying the status bar, displaying the notice information in the predetermined area may include determining a notice level corresponding to the notice information, the notice level used to indicate a rank of importance of the notice information, determining a display height of the notice information according to content and/or the notice level of the notice information, extending a display height of the status bar according to the display height of the notice information, and displaying the notice information in the status bar with the extended display height.

In one exemplary embodiment, the predetermined area may include at least one display page. Accordingly, the electronic device determines whether a number of pieces of notice information that are already displayed on a current display page in the predetermined area is less than a predetermined number, the predetermined number being a maximum number of pieces of notice information that can be displayed on the current display page in the predetermined area. If it is determined that the number of pieces of notice information displayed on the current display page in the predetermined area is less than the predetermined number, the electronic device displays the received notice information on the current display page in the predetermined area. If it is determined that the number of pieces of notice information displayed on the current display page in the predetermined area is not less than the predetermined number, the electronic device refreshes a display area displaying the piece of notice information that has a longest display time on the current display page, to display the received notice information.

In one exemplary embodiment, the method 100 may further include receiving a page turning signal that is configured to instruct a page turning of the current display page in the predetermined area, and turning the current display page in the predetermined area to another display page corresponding to the page turning signal.

In one exemplary embodiment, turning the displayed current display page in the predetermined area to another display page corresponding to the page turning signal may include turning, when the page turning signal instructs to turn the current display page in the predetermined area to a next display page and a next display page exists, the current display page in the predetermined area to the next display page; and turning, when the page turning signal instructs to turn the current display page in the predetermined area to a previous display page and a previous display page exists, the current display page to the previous display page in the predetermined area.

The method 100, by displaying the notice information in the area adjacent to the status bar or the area displaying the status bar, can alleviate or solve the problem that conventional methods of displaying notice information may affect the user's operation on information other than the notice information. Using the method 100, the electronic device informing the notice information to the user may not affect the user's operation.

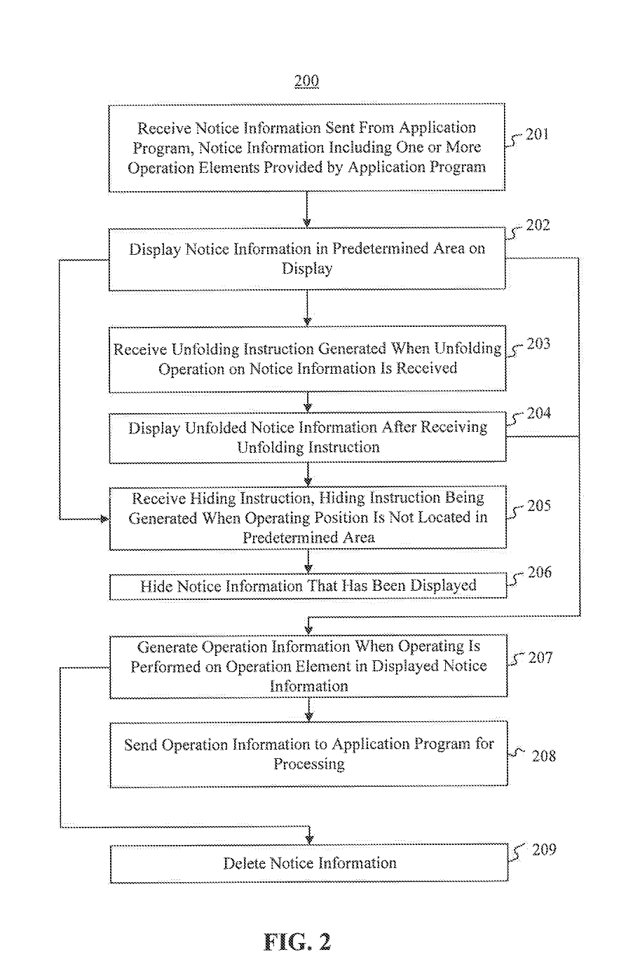

In exemplary embodiments, after the notice information is displayed in the predetermined area, the user can perform an operation on the displayed notice information, or ignore the notice information to perform other operations. For example, FIG. 2 is a flowchart of a method 200 for an electronic device to display notice information, according to an exemplary embodiment. Referring to FIG. 2, the method 200 can comprise the following steps.

In step 201, the electronic device receives notice information sent from an application program, the notice information including one or more operation elements provided by the application program. For example, the operation elements may include a selection button and/or a text input box. Also for example, the application program may be an application program installed in the electronic device, such as an application program for telephone communication, an application program for receiving and sending messages, an address book, a notepad, a browser, and the like.

In exemplary embodiments, the notice information is the information by the application program to notice a user. The notice information can include a text message used to inform the user regarding certain information. In addition, when the user needs to perform an operation after checking the text message, the application program can designate one or more operation elements in the sent notice information, such as a selection button and/or a text input box provided for the user's operations.

Based on different application programs, the notice information may include content related to the application programs. For example, when the application program is the application program for telephone communication, the notice information can include not only selection buttons, but characteristic content used to display the selection buttons in different colors. The characteristic content, for instance, can be used to display a select button in red that represents the function of hanging up the phone, and display a select button in green that represents a phone call can be picked up by selecting the green button. As another example, the notice information can include sound prompt information, to enable a speaker of the electronic device to implement the corresponding sound prompt when a status bar of the electronic device receives the notice information.

In step 202, the electronic device displays the notice information in a predetermined area on a display. For example, the predetermined area is an area displaying the status bar, or an area adjacent to the status bar.

In exemplary embodiments, the status bar displayed on the electronic device may be arranged along an edge of the display. For instance, the status bar can be arranged along the top edge, the bottom edge, the left side edge, or the right side edge of the display. The status bar can display current statuses of application programs, such as a battery power status, a system time, a wireless signal reception status, etc. Moreover, the status bar can display icons representing the generation of notice information by the application programs and corresponding to the application programs.

In exemplary embodiments, the predetermined area may be a relatively small area. This can prevent affecting the user's operation on other content displayed on the display when the notice information is displayed in the predetermined area. The predetermined area can be a rectangular area that is adjacent to the status bar in parallel, and can also be a rectangular area displaying the status bar. The predetermined area can also be of other shape, such as a circle, an ellipse, a polygon, etc.

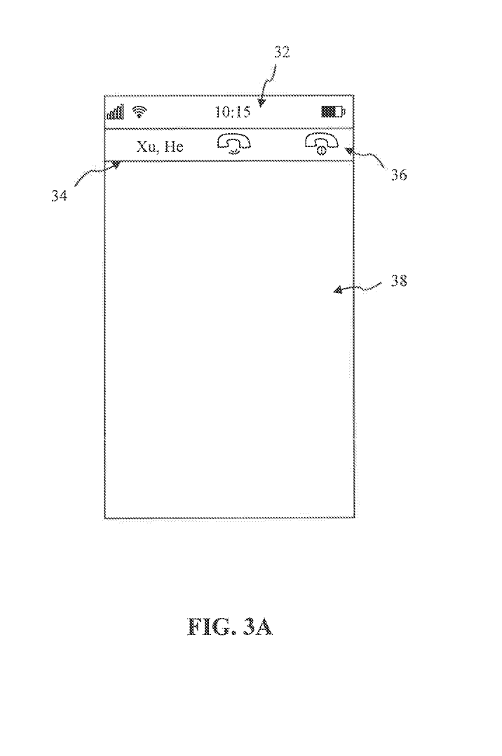

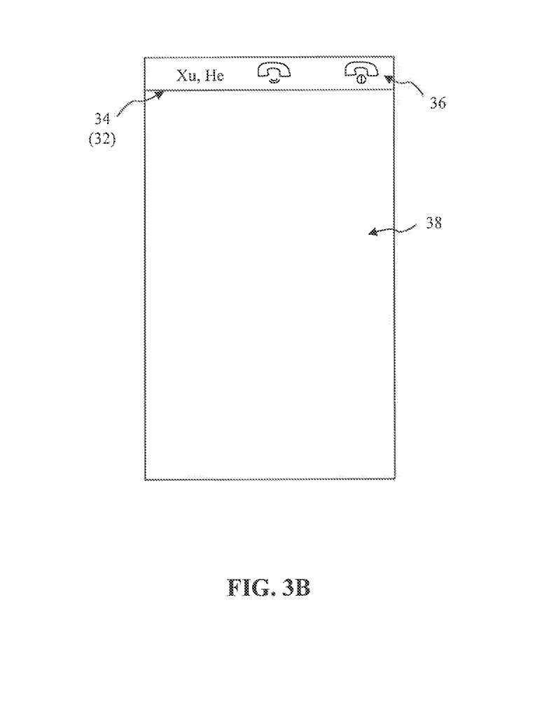

FIG. 3A is a view of a display 38 including a predetermined area 34 adjacent to a status bar 32, according to an exemplary embodiment. Referring to FIG. 3A, the status bar 32 is arranged along the top edge of the display 38. The predetermined area 34 is located under the status bar 32 and adjoins with the status bar 32. Notice information 36 is displayed in the predetermined area 34. Inasmuch as the status bar 32 is arranged along the top edge of the display 38 and the predetermined area 34 is relatively small, performing an operation on the notice information 36 has less impact on other content displayed on the display 38.

FIG. 3B is a view of the display 38 including an area displaying the status bar 32 as the predetermined area 34, according to an exemplary embodiment. The status bar 32 is arranged along the top edge of the display 38. The notice information 36 can be displayed in the status bar 32 after the status bar 32 is arranged as the predetermined area 34.

In exemplary embodiments, because the status bar, such as the status bar 32, may have a relatively small display area, when displaying the notice information in the status bar as the predetermined area, a display height of the status bar can be extended. The procedure of displaying the notice information in the status bar may include the following steps.

In step s1, a notice level corresponding to the notice information 36 is determined, the notice level being used to indicate a rank of importance of the notice information 36. The notice level can be set by the system, or by the user according to a need. For example, when the user thinks that an incoming call is important, the notice level of call notice information is set to be high. Also for example, when the user thinks that a short message is not important, the notice level of notice information for an unread short message is set to be low.

In step s2, a display height of the notice information is determined according to content and/or the notice level of the notice information. For example, the display height of the notice information can be determined according to a length of a text message, a number of selection buttons, etc. In one exemplary embodiment, when the predetermined area displays one piece of notice information, a display width of the one piece of notice information can be arranged the same as a width of the display.

Also for example, the display height of the notice information can be determined based on the notice level of the notice information. The notice information that has a higher notice level may have a higher display height to increase the user concern.

As another example, the display height of the notice information can be determined based on a combination of the length of the text message, the number of selection buttons, etc., and/or the notice level of the notice information. The notice information that has a higher notice level may be arranged to have a higher display height. A fine adjustment can be further performed on the display height of the notice information according to the length of the text message, the number of selection buttons, etc.

In step s3, the display height of the status bar is extended according to the display height of the notice information. For example, when the status bar needs to display only the received notice information as a first piece of notice information, the display height of the status bar can be extended according to the display height of the first piece of notice information. Also for example, when the status bar has sequentially displayed a plurality of pieces of notice information along a direction corresponding to the display height of the status bar, the display height of the status bar also can be extended according to the display height of the first piece of notice information. As another example, when the status bar has sequentially displayed at least one piece of notice information along a direction corresponding to a display width of the status bar, if the display height of the first piece of notice information is greater than the maximum display height of the status bar, the display height of the status bar can be extended to be the same as the display height of the first piece of notice information. If the display height of the received notice information is less than the maximum display height of the status bar, no extension of the display height of the status bar is needed.

In step s4, the notice information is displayed in the status bar with the extended display height. For example, FIG. 3B shows the status bar 32 whose display height has been extended. There is one piece of notice information 36 displayed in the status bar 32.

In exemplary embodiments, to reduce a cover area of the display by notice information in the predetermined area, the display height of the notice information can be set to be less than a predetermined threshold value. When there are a lot of content of the notice information to be displayed, and the display height of the notice information needs to be limited less than the predetermined threshold value, a part of the content of the notice information can be displayed in the predetermined area having the display height corresponding to the predetermined threshold value. The user generally can infer a type of the notice information according to the displayed part of the content. For instance, the user generally can infer whether the notice information is a spam message, a call notice, or an upgrade notice for an application program.

In one exemplary embodiment, when all of the content included in the notice information cannot be displayed completely because the display height of the notice information is limited by the predetermined threshold value, additional content can be displayed by arranging a scrolling bar along the direction corresponding to the display height of the notice information or the display width of the notice information.

In exemplary embodiments, to prevent affecting the user's operation on content other than the notice information, the predetermined area is generally arranged to be relatively small. Correspondingly, the notice information is displayed in the predetermined area relatively small. If the user checks the notice information and needs to perform an operation on the notice information, the user can unfold the notice information to perform the operation on the unfolded notice information. Accordingly, before the operation on the notice information, the method 200 may further include step 203 and step 204.

In step 203, an unfolding instruction is generated when an unfolding operation on the notice information is received from the user. For example, the unfolding operation can be a pressing operation of pressing the notice information for at least a predetermined time period, a click operation of clicking the notice information continuously at least twice, or a sliding operation of sliding over the notice information downward. The unfolding instruction is generated when the unfolding operation is received, which means that the user needs to check or operate on content of the notice information. Correspondingly, the status bar receives the unfolding instruction.

In step 204, the unfolded notice information is displayed after the unfolding instruction is received. For example, a manner of unfolding the notice information is determined in accordance with the content included in the notice information.

In one exemplary embodiment, when there is less content in the notice information, all of the content is displayed in the predetermined area. In addition, because the notice information is initially displayed relatively small, the notice information may be enlarged directly, and then the enlarged notice information can be displayed.

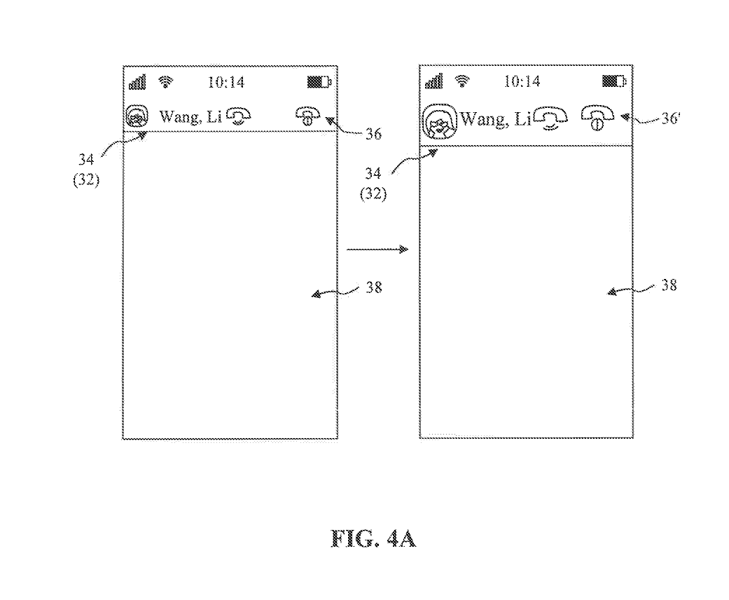

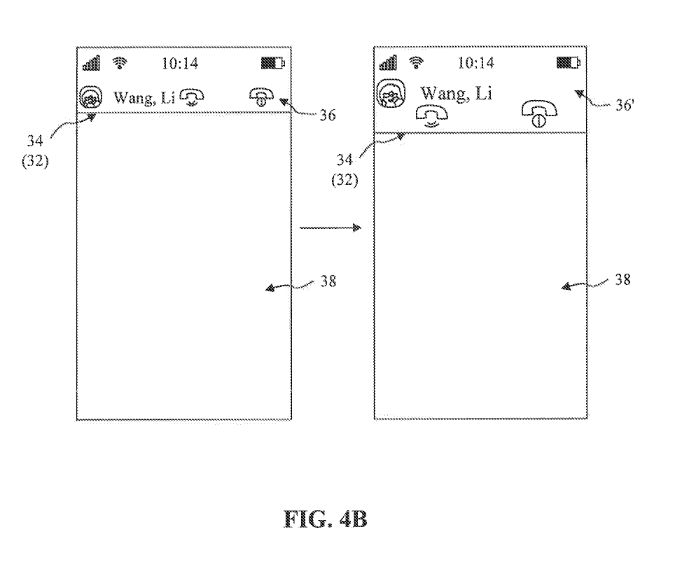

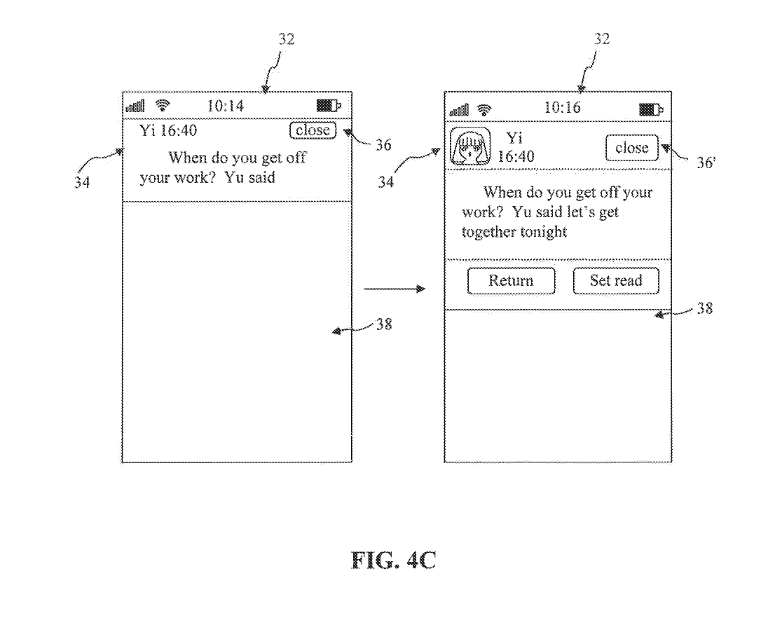

For example, FIG. 4A is a view of the display 38 in enlarging notice information, such as the notice information 36, according to an exemplary embodiment. In the illustrated embodiment, the predetermined area 34 is the area displaying the status bar 32. Referring to FIG. 4A, before receiving the unfolding instruction, all of the content included in the notice information 36 is displayed in the predetermined area 34. After the unfolding instruction is received, the notice information 36 can be enlarged directly to be notice information 36′ having an appropriate display size. In other words, the display height of the notice information is increased. Text messages and operation elements in the enlarged notice information 36′ are enlarged by the same scale as the notice information 36.

In one exemplary embodiment, when there is less content in the notice information, all of the content is displayed in the predetermined area. In addition, because the notice information is initially displayed relatively small, after receiving the unfolding instruction, the notice information can be enlarged and rearranged, and then the enlarged and rearranged notice information can be displayed. The enlarging and rearranging of the notice information can provide an aesthetic arrangement of the notice information and match the user's operation habits.

For example, FIG. 4B is a view of the display 38 in enlarging notice information, such as the notice information 36, according to an exemplary embodiment. In the illustrated embodiment, the predetermined area 34 is the area displaying the status bar 32. Referring to FIG. 4B, all of the content included in the notice information 36 is displayed in the predetermined area 34. After the unfolding instruction is received, the content in the notice information 36 can be enlarged and rearranged to be the unfolded notice information 36′ for convenience of the user operation.

In one exemplary embodiment, when there is more content in the notice information, all of the content may not be displayed in the predetermined area at the same time. Accordingly, after the unfolding instruction is received, the notice information can be unfolded. For instance, more content can be displayed in the unfolded notice information. Alternatively and/or additionally, the content originally displayed in the notice information can be rearranged, and then the unfolded notice information can be displayed.

For example, FIG. 4C is a view of the display 38 in unfolding notice information, such as the notice information 36, according to an exemplary embodiment. In the illustrated embodiment, the predetermined area 34 is an area adjacent to the status bar 32. Referring to FIG. 4C, not all of the content included in the notice information 36 is displayed in the predetermined area 34, such as a text message or certain operation elements. After the unfolding instruction is received, the notice information 36 may be unfolded to an appropriate display size. Because the unfolded notice information 36′ may need to display more content that has not been displayed before the notice information is unfolded, an enlargement scale of text messages and operation elements in the notice information 36 may be less than an enlargement scale of the notice information 36. Due to the display size of the notice information 36 becoming larger, the content in the unfolded notice information 36′ can be rearranged for convenience of the user operation.

In the above embodiments in FIGS. 4A to 4C, the unfolded notice information can be unfolded or enlarged to a predetermined display size. The predetermined display size generally is smaller than a size of the display 38. For instance, the unfolded notice information 36′ can be unfolded or enlarged to a predetermined display height which generally is smaller than a height of the display 38. Accordingly, the user, who wants to perform another operation on content other than the notice information, may do so on an area outside where the notice information is displayed on the display 38. The predetermined display size can also be the same as the size of the display 38. After the user completes the operation on the notice information, the notice information may be deleted. The display 38 can then return to the original user interface.

In the illustrated embodiment, after the user checks the notice information displayed in step 202, or the unfolded notice information displayed in step 204, the notice information can be chosen to ignore, e.g., when the user thinks that there is no need to check the notice information temporarily. Further, the notice information that has been displayed can be hidden temporarily for reducing an impact on subsequent user operations.

Referring back to FIG. 2, in step 205, a hiding instruction is generated when an operating position of the user's operation is located beyond the predetermined area. In other words, when the operating position is not located in the predetermined area, the hiding instruction is received.

In step 206, the notice information that has been displayed is hidden. For example, when the operating position is not located in the predetermined area, which means that the user will not operate on the content in the notice information temporarily, the notice information that has been displayed may be hidden at this time.

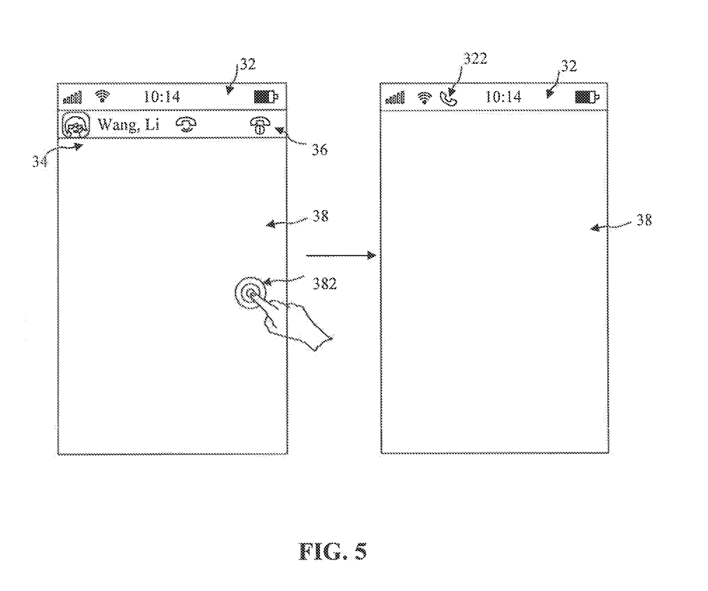

FIG. 5 is a view of the display 38 in hiding notice information that has been displayed, such as the notice information 36, according to an exemplary embodiment. In the illustrated embodiment, the notice information 36 has been displayed in the predetermined area 34 adjacent to the status bar 32. When the user operates at a position 382 that is beyond the predetermined area 34 on the display 38, the notice information 36 is hidden. Moreover, for example, when the notice information has been displayed in the status bar 32 as the predetermined area 34, and the user operation is not positioned in the predetermined area 34, the notice information displayed in the status bar 32 can be hidden. Generally, after the notice information 36 is hidden, to remind the existing notice information to the user, an icon corresponding to the notice information can be displayed in the status bar 32, such as a missed-call icon 322.

In one exemplary embodiment, the user may need to hide the status bar when playing a game on the electronic device. If the notice information is displayed in the status bar, when the status bar is hidden, the notice information is also hidden.

In exemplary embodiments, after the user checks the notice information displayed in step 202, or the unfolded notice information displayed in step 204, the user can perform an operation on an operation element included in the displayed notice information. That is, the user can perform an operation directly on an operation element in the notice information displayed in step 202, or perform an operation on an operation element in the unfolded notice information displayed in step 204.

In step 207, operation information is generated when an operation is performed on the operation element in the displayed notice information. For instance, when the application program for telephone communication sends the notice information to the status bar, operation elements in the notice information to be displayed in the status bar can include an answer key and a hang up key. When the user selects the answer key or the hang up key, the operation information corresponding to the selected key is generated.

In step 208, the operation information is sent to the application program for processing. The application program implements a process according to the received operation information. For example, after the application program receives the operation information, the application program can implement the process in a back stage without switching a currently displayed interface to an interface associated with the application program.

In step 209, the notice information is deleted. Generally, after the operation information is generated, the generated operation information can be sent to the application program for processing directly in the back stage. At this time, there is no need to continue displaying the notice information and, therefore, the notice information can be deleted.

In exemplary embodiments, step 205 can be performed directly following step 202, or following step 204. In addition, step 207 can be performed directly following step 202 or following step 204.

The method 200, by displaying the notice information in the area adjacent to the status bar or the area displaying the status bar, can mitigate or solve the problem that conventional methods of displaying notice information may affect the user's operation on information other than the notice information. Using the method 200, the electronic device informing the notice information to the user may not affect the user's operation.

In one exemplary embodiment, when the status bar receives a piece of new notice information, and a piece of old notice information has been displayed in the predetermined area adjacent to the status bar or in the status bar, the piece of old notice information in the predetermined area can be replaced by the piece of new notice information. In other words, the last received notice information is displayed in the predetermined area.

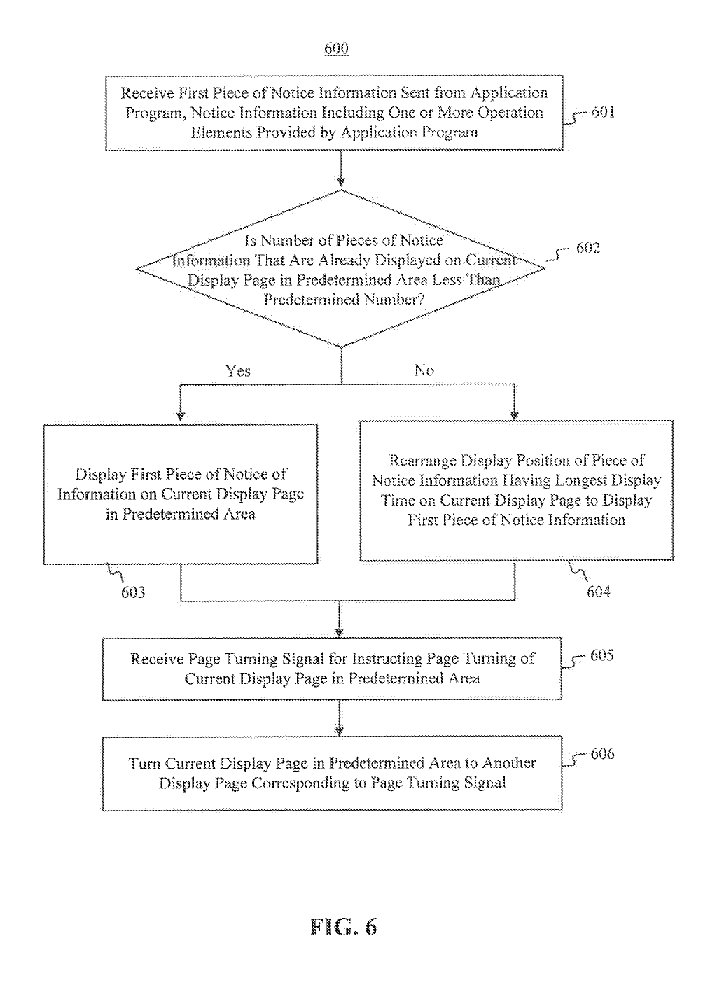

FIG. 6 is a flow chart of a method 600 for an electronic device to display notice information, according to an exemplary embodiment. Referring to FIG. 6, the method 600 can comprise the following steps.

In step 601, the electronic device receives a first piece of notice information sent from an application program, the first piece of notice information including one or more operation elements provided by the application program. For example, the operation elements may include a selection button and/or a text input box.

In step 602, it is determined whether a number of pieces of notice information that are already displayed on a current display page in the predetermined area is less than a predetermined number. The predetermined area can be an area displaying the status bar, or an area adjacent to the status bar. The predetermined number is a maximum number of pieces of notice information that can be displayed on the current display page in the predetermined area.

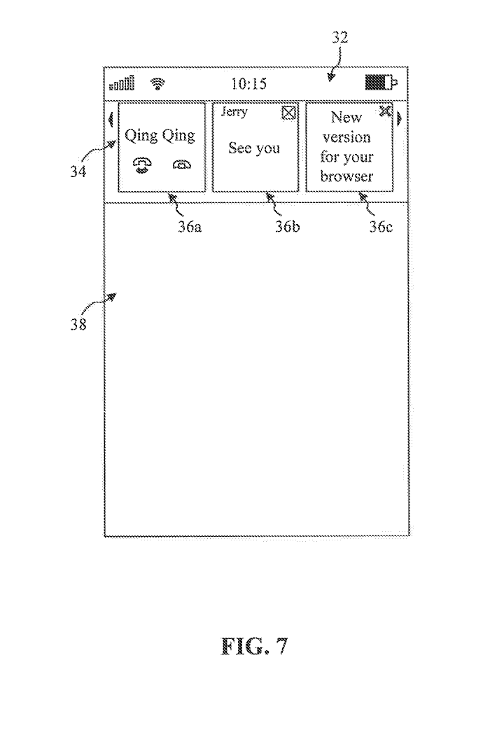

In exemplary embodiments, when multiple pieces of notice information need to be displayed, multiple display pages can be arranged in the status bar, or in the area adjacent to the status bar. One page is displayed each time, and each page can display at least one piece of notice information. A maximum number of pieces of notice information that can be displayed on each display page may be set to be the same. For example, FIG. 7 is a view of the display 38 displaying a plurality of pieces of notice information on a current display page in the predetermined area 34, according to an exemplary embodiment. Referring to FIG. 7, first, second, and third pieces of notice information 36a, 36b, and 36c are displayed in the predetermined area 34 adjacent to the status bar 32.

Referring back to FIG. 6, in step 603, if it is determined that the number of pieces of notice information displayed on the current display page in the predetermined area is less than the predetermined number, the first piece of notice information is displayed on the current display page of the predetermined area. For instance, if two pieces of notice information have been displayed on the current display page of the predetermined area, and if the maximum number of pieces of notice information that can be displayed in the current display page is greater than two, the first piece of notice information also can be displayed in the current display page.

In step 604, if it is determined that the number of pieces of notice information displayed on the current display page in the predetermined area is not less than the predetermined number, a display position of a piece of the notice information having a longest display time on the current display page may be rearranged to display the first piece of notice information.

For example, when the status bar includes multiple pieces of notice information, the first piece of notice information, which is the last received notice information, may be important information and needs to be processed immediately by the user. To enable that the user can check the first piece of notice information in time, the position of the piece of notice information having the longest display time on the current display page of the predetermined area is rearranged for displaying the first piece of notice information.

In step 605, a page turning signal is received to instruct a page turning of the current display page in the predetermined area. For example, the turning page signal is a signal generated by a sliding touch in accordance with a predetermined track on the current display page, or by selecting a page turning button arranged on the current display page.

For example, when the status bar sequentially displays multiple pieces of notice information according to a direction corresponding to a display width of the status bar, the predetermined track can be a sliding path from the right side to the left side, or an opposite sliding path thereto. Also for example, when the status bar sequentially displays multiple pieces of notice information according to a direction corresponding to a display height of the status bar, the predetermined track can be a sliding path from the top side to the down side, or an opposite sliding path thereto. The page turning button can be a button for instructing to turn the current display page to a previous display page, or to turn the current display page to a next display page.

In step 606, the current display page in the predetermined area is turned to another display page corresponding to the page turning signal.

In one exemplary embodiment, when the turning page signal is used to instruct to turn the current display page in the predetermined area to the next display page and the next page exists, the current display page is turned to the next page in the predetermined area.

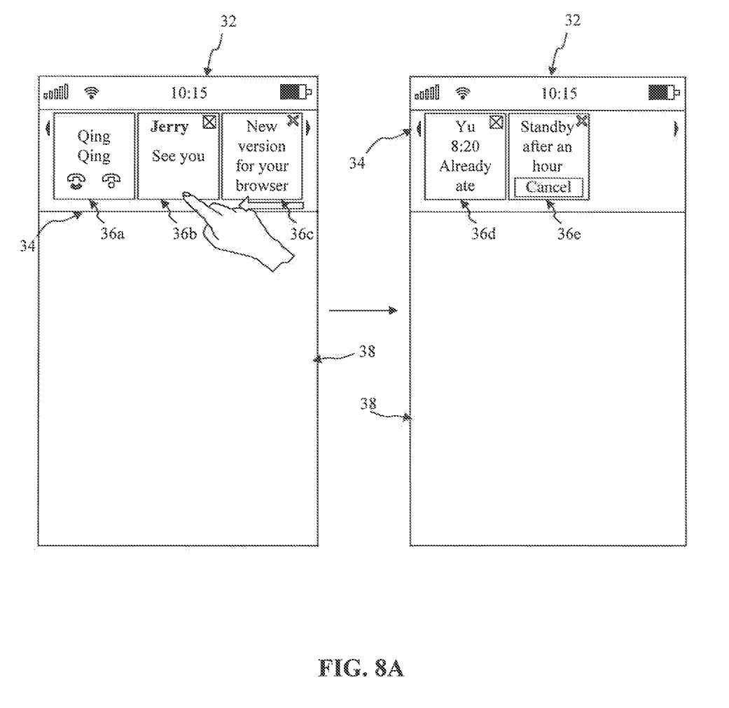

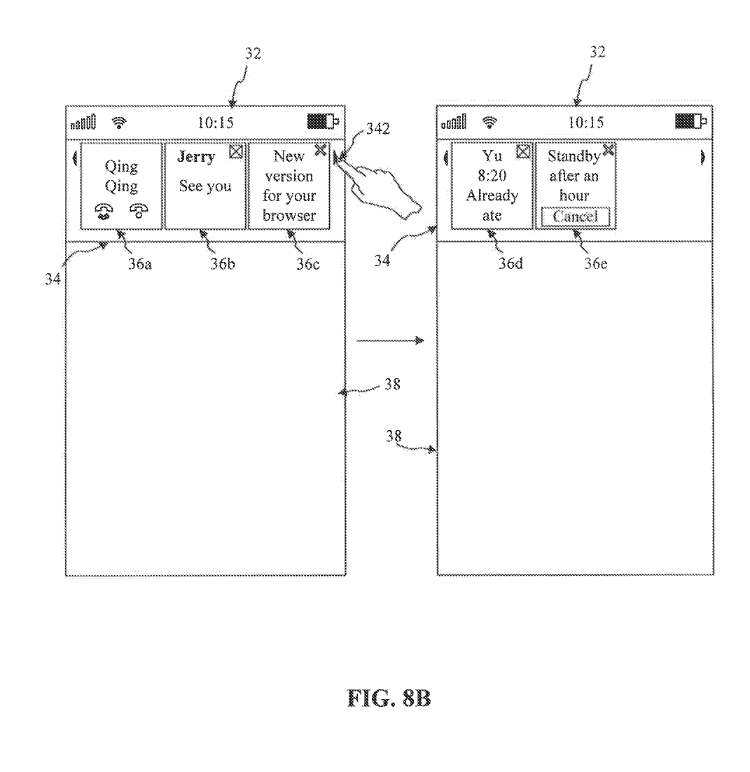

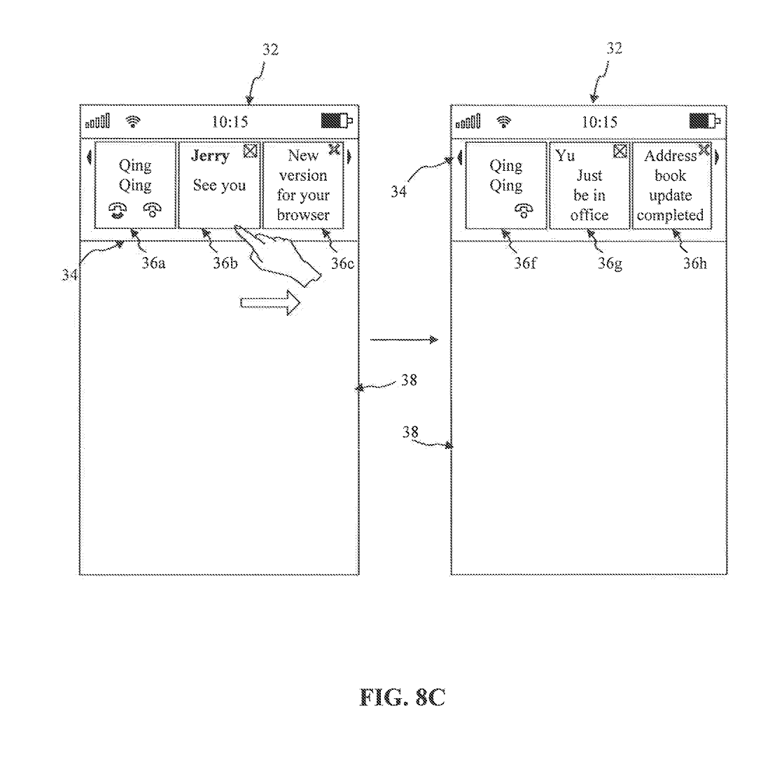

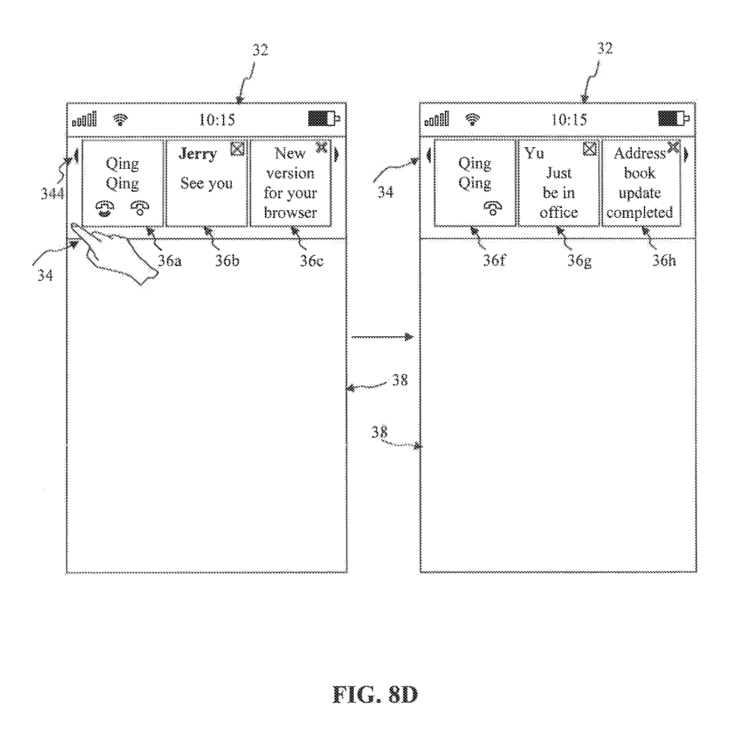

FIG. 8A is a view of the display 38 in turning the current display page to the next display page in the predetermined area 34, according to an exemplary embodiment. In the illustrated embodiment, multiple pieces of notice information are arranged sequentially according to the direction corresponding to the display width of the status bar 32. When the user touches the current display page in the predetermined area 34 by, e.g., sliding a finger from the right side to the left side, the turning page signal is generated to instruct to turn the current display page to the next display page. If the next display page exists, the current display page is turned to the next page. Referring to FIG. 8A, before turning the current display page to the next display page, the first, second, and third pieces of notice information 36a, 36b, and 36c are displayed on the current display page. After the current display page is turned to the next display page, the predetermined area 34 displays fourth and fifth pieces of notice information 36d and 36e.

FIG. 8B is a view of the display 38 in turning the current display page to the next display page in the predetermined area 34, according to another exemplary embodiment. In the illustrated embodiment, multiple pieces of notice information are arranged sequentially according to the direction corresponding to the display width of the status bar 32. When the user selects a page turning button 342 arranged on the current display page, the turning page signal is generated to instruct to turn the current display page to turn to the next page. If the next display page exists, the current display page displayed in the predetermined area 34 is turned to the next display page. Referring to FIG. 8B, before turning the current display page to the next display page, the first, second, and third pieces of notice information 36a, 36b, and 36c are displayed on the current display page. After the current display page is turned to the next display page, the predetermined area 34 displays the fourth and fifth pieces of notice information 36d and 36e.

In one exemplary embodiment, when the turning page signal is used to instruct to turn the current display page in the predetermined area to the previous display page and the previous display page exists, the current display page is turned to the previous display page in the predetermined area.

FIG. 8C is a view of the display 38 in turning the current display page to the previous display page in the predetermined area 34, according to an exemplary embodiment. In the illustrated embodiment, multiple pieces of notice information are arranged sequentially according to the direction corresponding to the display width of the status bar 32. When the user touches the current display page in the predetermined area 34 by, e.g., sliding a finger from the left side to the right side, the turning page signal is generated to instruct to turn the current display page in the predetermined area 34 to the previous display page. If the previous display page exists, the current display page displayed in the predetermined area 34 is turned to the previous display page. Referring to FIG. 8C, before turning the current display page to the previous display page, the first, second, and third pieces of notice information 36a, 36b, and 36c are displayed on the current display page. After the current display page is turned to the display previous page, the predetermined area 34 displays sixth, seventh, and eighth pieces of notice information 36f, 36g, and 36h.

FIG. 8D is a view of the display 38 in turning the current display page to the previous display page in the predetermined area 34, according to an exemplary embodiment. In the illustrated embodiment, multiple pieces of notice information are arranged sequentially according to the direction corresponding to the display width of the status bar 32. When the user selects a page turning button 344 arranged on the current display page, the turning page signal is generated to instruct to turn the current display page in the predetermined area to the previous page. If the previous display page exists, the current display page displayed in the predetermined area 34 is turned to the previous display page. Referring to FIG. 8D, before turning the current display page to the previous display page, the first, second, and third pieces of notice information 36a, 36b and 36c are displayed on the current display page. After the current display page is turned to the previous display page, the predetermined area 34 displays the sixth, seventh, and eighth pieces of notice information 36f, 36g, and 36h.

In exemplary embodiments, when the current display page displays multiple pieces of notice information, a size of each piece of notice information being displayed may be small. When the user needs to perform an operation on one of the pieces of notice information displayed on the current display page, the user can unfold the one of the pieces of notice information, and operation information is generated by the user's operation on an operation element in the unfolded notice information. The operation information is sent to the application program corresponding to the one piece of notice information for processing. In addition, after the operation information is generated, the unfolded notice information and an icon corresponding to the one piece of notice information may be deleted.

In exemplary embodiments, when the user performs an operation on content other than that displayed in the predetermined area, all of the pieces of notice information in the predetermined area can be hidden at this time. Moreover, icons corresponding to the pieces of notice information, such as a missed-call icon, a system upgrade icon, an unread-message icon, etc. may not be displayed in the status bar.

The method 600, by displaying multiple pieces of notice information in the area displaying the status bar or the area adjacent to the status bar, can mitigate or solve the problem that the user may miss important notice information that is received earlier.

In one exemplary embodiment, a priority level can be determined for each piece of notice information in accordance with a corresponding relationship between application programs and priority levels of the respective application programs, and different reminders can be set for the pieces of notice information with different priority levels. For example, different colors can be set for text messages corresponding to the pieces of notice information with different priority levels. Moreover, different sound prompts can be implemented in displaying the pieces of notice information with different priority levels.

In one exemplary embodiment, a priority level can be determined for each piece of notice information in accordance with a corresponding relationship between application programs and priority levels of the respective application programs, and the pieces of notice information can be displayed according to their respective priority levels.

In one exemplary embodiment, a sound prompt can be determined for each piece of notice information in accordance with a corresponding relationship between application programs and sound prompts of the respective application programs, and the user is prompted according to the determined sound prompt.

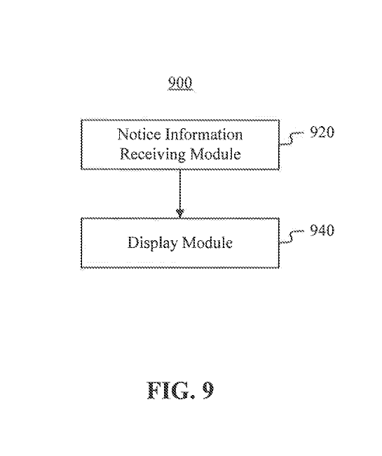

FIG. 9 is a block diagram of an apparatus 900 for displaying notice information, according to an exemplary embodiment. The apparatus 900 can be applied to a variety of electronic devices, such as a smart phone, a tablet computer, a personal digital assistant (PDA), an intelligent TV, an E-book reader, a moving picture experts group audio layer III (MP3) player, a moving picture experts group audio layer IV (MP4) player, a notebook, a personal computer, etc. The apparatus 900 can comprise a notice information receiving module 920 and a display module 940.

The notice information receiving module 920 is configured to receive notice information sent from an application program. The notice information may include one or more operation elements provided by the application program. For example, the operation elements may include a selection button and/or a text input box.

The display module 940 is configured to display the notice information which the notice information receiving module 920 receives in a predetermined area. The predetermined area can be an area displaying a status bar, or an area adjacent to the status bar. The status bar may be arranged along an edge of a display.

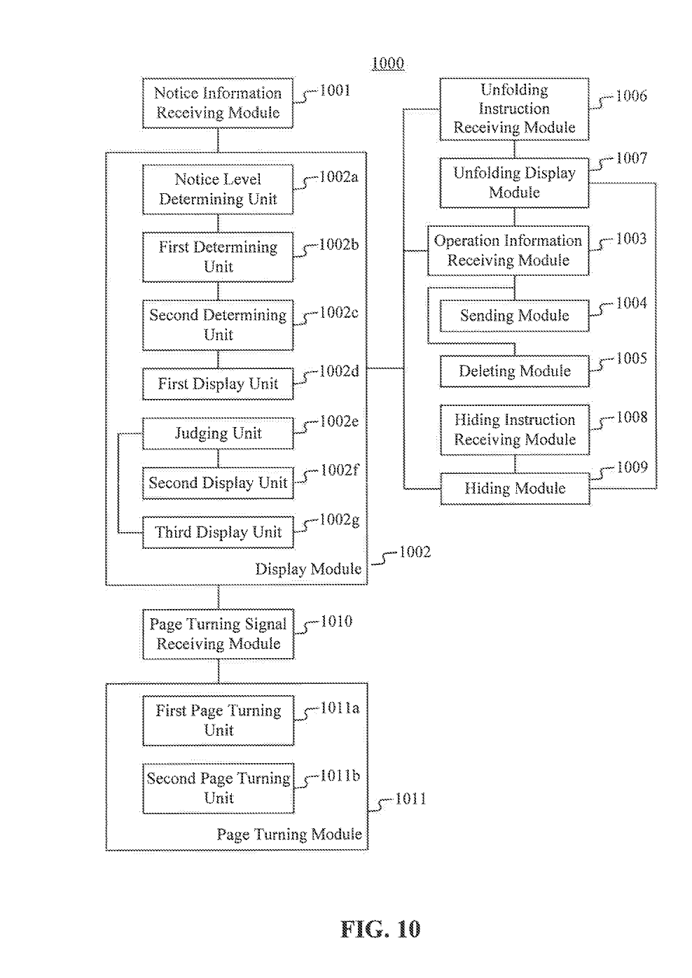

FIG. 10 is a block diagram of an apparatus 1000 for displaying notice information, according to another exemplary embodiment. The apparatus 1000 can be applied to a variety of electronic devices such as a smart phone, a tablet computer, a personal digital assistant (PDA), an intelligent TV, an E-book reader, a moving picture experts group audio layer III (MP3) player, a moving picture experts group audio layer IV (MP4) player, a notebook, a personal computer, etc. The apparatus 1000 can comprise a notice information receiving module 1001 and a display module 1002.

The notice information receiving module 1001 is configured to receive notice information sent from an application program. The notice information may include one or more operation elements provided by the application program. For example, the operation elements may include a selection button and/or a text input box.

The display module 1002 is configured to display the notice information which the notice information receiving module 1001 receives in a predetermined area. The predetermined area can be an area displaying a status bar, or an area adjacent to the status bar. The status bar is arranged along an edge of a display.

In exemplary embodiments, the apparatus 1000 may further include an operation information receiving module 1003 and a sending module 1004.

The operation information receiving module 1003 is configured to receive operation information that is generated when an operation element displayed in the notice information is operated.

The sending module 1004 is configured to send the operation information which the operation information receiving module 1003 receives to the application program for processing. The application program implements a process according to the received operation information.

In exemplary embodiments, the apparatus 1000 may further include a deleting module 1005. The deleting module 1005 is configured to delete the displayed notice information after the operation receiving module 1003 receives the operation information.

In exemplary embodiments, the apparatus 1000 may further include an unfolding instruction receiving module 1006 and an unfolding display module 1007.

The unfolding instruction receiving module 1006 is configured to receive an unfolding instruction generated when an unfolding operation on the displayed notice information is performed.

The unfolding display module 1007 is configured to display the unfolded notice information after the unfolding instruction receiving module 1006 receives the unfolding instruction.

In exemplary embodiments, the operation information receiving module 1003 further receives the operation information generated when an operation element in the unfolded notice information is operated.

In exemplary embodiments, the apparatus 1000 may further include a hiding instruction receiving module 1008 and a hiding module 1009.

The hiding instruction receiving module 1008 is configured to receive a hiding instruction generated when an operating position is not located in the predetermined area.

The hiding module 1009 is configured to hide the notice information that has been displayed by the display module 1002, or the unfolded notice information that has been displayed by the unfolding display module 1007.

In exemplary embodiments, when the predetermined area is an area displaying the status bar, the display module 1002 may include a notice level determining unit 1002a, a first determining unit 1002b, a second determining unit 1002c, and a first display unit 1002d.

The notice level determining unit 1002a is configured to determine a notice level corresponding to the notice information. The notice level indicates a rank of importance of the notice information.

The first determining unit 1002b is configured to determine a display height of the notice information according to content and/or the notice level of the notice information.

The second determining unit 1002c is configured to extend a display height of the status bar according to the display height of the notice information.

The first display unit 1002d is configured to display the notice information in the status bar with the extended display height.

In exemplary embodiments, the predetermined area may include at least one display page. Accordingly, the display module 1002 may further include a judging unit 1002e, a second display unit 1002f, and a third display unit 1002g.

The judging unit 1002e is configured to judge whether a number of pieces of notice information displayed on a current display page in the predetermined area is less than a predetermined number. For example, the predetermined number is a maximum number of pieces of notice information that can be displayed on the current display page in the predetermined area.

The second display unit 1002f is configured to display the notice information on the current display page in the predetermined area when it is determined that the number of pieces of notice information displayed on the current display page in the predetermined area is less than the predetermined number.

The third display unit 1002g is configured to rearrange a position of a piece of notice information having a longest display time on the current display page in the predetermined area, to display the newly received notice information, when it is determined that the number of pieces of notice information displayed on the current display page is not less than the predetermined number.

In exemplary embodiments, the apparatus 1000 may further include a page turning signal receiving module 1010 and a page turning module 1011.

The page turning signal receiving module 1010 is configured to receive a page turning signal that instructs a page turning of the current display page in the predetermined area.

The page turning module 1011 is configured to turn the current display page in the predetermined area to another display page corresponding to the page turning signal.

In exemplary embodiments, the page turning module 1011 may further include a first page turning unit 1011a and a second page turning unit 1011b.

The first page turning unit 1011a is configured to turn the current display page in the predetermined area to a next display page when the page turning signal instructs to turn the current display page to a next display page and the next display page exists.

The second page turning unit 1011b is configured to turn the current display page in the predetermined area to a previous display page when the page turning signal instructs to turn the current display page in the predetermined area to a previous page and the previous display page exists.

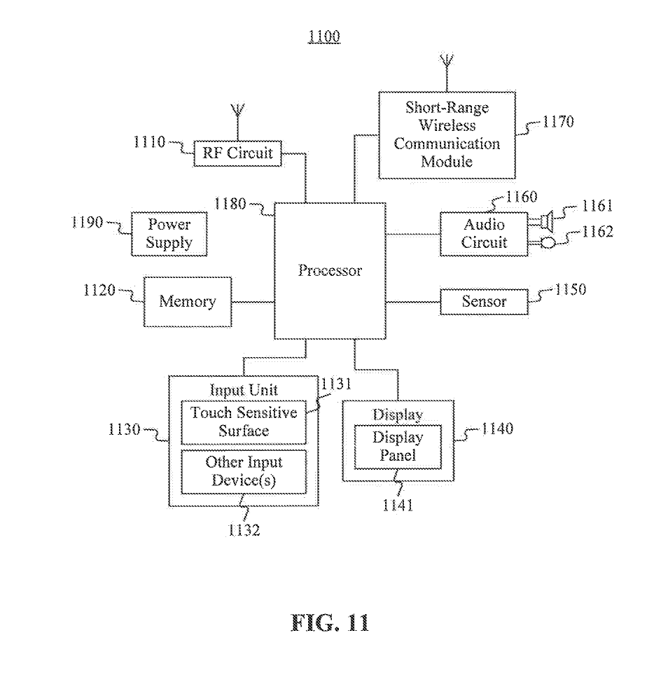

FIG. 11 is a block diagram of an electronic device 1100, according to an exemplary embodiment. The electronic device 1100 is configured to perform any of the above described methods for displaying notice information. Referring to FIG. 11, the electronic device 1100 may include one or more of a radio frequency (RF) circuit 1110, memory resources represented by a memory 1120, an input unit 1130, a display 1140, a sensor 1150, an audio circuit 1160, a short-range wireless communication module 1170, a processor 1180, and a power supply 1190. One skilled in the art will appreciate that the structure of the electronic device 1100 is not limited to that shown in FIG. 11. The electronic device 1100 may include less or more components than those shown in FIG. 11, or include a combination of some components, or include various component arrangement.

The RF circuit 1110 is configured to send and receive signals during sending and receiving of information or a process of calling. For example, the RF circuit 1110 receives downlink information from a base station and then transmits the downlink information to the processor 1180 to be processed. Moreover, the RF circuit 1110 transmits related uplink data to the base station. Generally, the RF circuit 1110 includes, but is not limited to, an antenna, at least one amplifier, a tuner, one or more oscillators, a transceiver, a coupler, a low noise amplifier (LNA), a duplexer, and the like. Additionally, the RF circuit 1110 may also communicate with a network or other devices via a wireless network. The wireless network may adopt a communication standard or protocol including, but not limited to, global system of mobile communication (GSM), general packet radio service (GPRS), code division multiple access (CDMA), wideband code division multiple access (WCDMA), long term evolution (LTE), email, short messaging service (SMS), and the like.

The memory 1120 is configured to store software programs and modules. The processor 1180 performs various functions and processes data through executing software programs and modules stored in the memory 1120. The memory 1120 may include a program storage area and a data storage area. The program storage area may store an operating system, at least one application program required by at least one function (such as a sound play function, an image play function, and the like). The data storage area may store data created based on operation of the electronic device 1100 (such as audio data, a phone book, and the like). In addition, the memory 1120 may include a high speed random access memory. The memory 1120 may also include a nonvolatile memory, such as a disk storage, a flash memory or other nonvolatile solid-state memories. Correspondingly, the memory 1120 may also include a memory controller to control access to the memory 1120 performed by the processor 1180 and the input unit 1130.

The input unit 1130 is configured to receive input information of numbers or characters and to generate signal input through a keyboard, a mouse, a joystick, an optical device, or a trackball related to user settings and function control. For example, the input unit 1130 may include a touch sensitive surface 1131 and one or more other input devices 1132. The touch sensitive surface 1131, also called a touch screen or a track pad, may collect a touch operation on or near it (for example, when the user performs an operation on or near the touch sensitive surface 1131 with a finger, a stylus, or any suitable object or attachment), and drive a corresponding connection device according to a preset program. Alternatively, the touch sensitive surface 1131 may include first and second parts, i.e., a touch detecting device and a touch controller. The touch detecting device detects a touch orientation performed by the user and signals from the touch operation, and transmits the signals to the touch controller as touch information. The touch controller receives the touch information from the touch detecting device and converts it into touch point coordinates and then transmits the coordinates to the processor 1180. The touch controller also receives and performs instructions from the processor 1180. Additionally, the touch sensitive surface 1131 may be realized as a resistance touch sensitive surface, a capacitive touch sensitive surface, an infrared ray touch sensitive surface, a surface acoustic wave (SAW) touch sensitive surface, and the like. The input unit 1130 may also include one or more other input devices 1132. For example, the other input devices 1132 may include, but are not limited to, one or any combination of a physical keyboard, a function key (such as a volume control key, an on/off key, and the like), a trackball, a mouse, a joy stick.

The display 1140 is configured to display information input by the user or information provided to the user, and various graphic user interfaces (GUIs) formed by an image, a text, an icon, a video and any combination of them. The display 1140 may include a display panel 1141. The display panel 141 may be configured with a liquid crystal display (LCD), an organic light-emitting diode (OLED), and the like. Furthermore, the touch sensitive surface 1131 may be configured to cover the display panel 1141. When detecting the touch operation performed on or near the touch sensitive surface 1131, the touch sensitive surface 1131 transmits signals to the processor 1180 to determine a type of the touch operation, then the processor 1180 provides corresponding visual output on the display panel 1141 according to the type of the touch operation. Although the touch sensitive surface 1131 and the display panel 1141 are shown as two separate parts in FIG. 11 to perform input and output functions, the touch sensitive surface 1131 may be integrated with the display panel 1141 in some embodiments to perform input and output functions.

The sensor 1150 may be a photo sensor, a motion sensor, or any other sensors. For example, the photo sensor may include an ambient light sensor and a proximity sensor. The ambient light sensor may adjust brightness of the display panel 1141 according to intensity of the ambient light. The proximity sensor may close the display panel and/or backlight when the electronic device 1100 is close to the user's ear. As an example of the motion sensor, a gravity acceleration sensor may detect values of accelerations in various directions (e.g., along three axes), and may detect a value and a direction of the gravity when in a stationary state. The gravity acceleration sensor may be used in applications for identifying an orientation of the electronic device 1100 (such as switching between a landscape mode and a vertical mode, corresponding games, magnetometer pose adjustment), functions related to vibration (such as a pedometer, knocking), and the like. Other sensors which may be arranged in the electronic device 1100 include a gyroscope, a barometer, a hygrometer, a thermometer, an infrared sensor, and the like.

The audio circuit 1160 is coupled to a speaker 1161 and a microphone 1162, and may provide an audio interface between the user and the electronic device 1100. The audio circuit 1160 may convert received audio data into electronic signals and transmit the electronic signals to the speaker 1161, and the speaker 1161 may convert the electronic signals into voice and output the voice. Additionally, the microphone 1162 may convert collected voice signals into electronic signals to send to the audio circuit 160, which receives the electronic signals and converts them into audio data. The audio data may be transmitted to the processor 1180 for processing and then transmitted to another terminal device via the RF circuit 1110. The audio data may also be transmitted to the memory 1120 to be further processed. The audio circuit 1160 may also include an earplug jack to allow communication between a peripheral earphone and the electronic device 1100.

The short-range wireless communication module 1170 may be a wireless fidelity (WiFi) module. The electronic device 1100 may implement applications of e-mail service and web page and streaming medium browsing using the short-range wireless communication module 1170, which provides a broadband wireless communication with the Internet. Although the short-range wireless communication module 1170 is shown in FIG. 11, it should be understood that the wireless communication unit 1170 is not a necessary component of the electronic device 1100 and may be omitted based on actual needs

The processor 1180 is a control center of the electronic device 1100 and is connected to respective parts of the electronic device 1100 via various interfaces and line links, and performs various functions and processes data through executing software programs and calling data stored in the memory 1120, so as to achieve an overall control of the electronic device 1100. The processor 1180 may include one or more processing cores. In one exemplary embodiment, the processor 1180 may be integrated with an application processor and a modem. The application processor is mainly used to control the operating system, user interfaces, applications, and the like. The modem is mainly used to handle the wireless communication. The modem may also be provided independently of the processor 1180.

The power supply 1190 provides power to components of the electronic device 1100. For example, the power supply 1190 may be logically connected to the processor 1180 through a power control system, so that the power control system may implement a power charge-discharge management and a power consumption management. The power supply 1190 may also include any components such as one or more direct current (DC) or (alternating current) AC power supply, a recharge system, a power fault detecting circuit, a power adapter or inverter, a power status indicator, and the like.

Although not shown, the electronic device 1100 may also include a camera, a Bluetooth module touch panel, etc.

In exemplary embodiments, there is also provided a non-transitory readable storage medium including instructions, such as included in the memory 1120, executable by the processor 1180 in the electronic equipment 1100, for performing the above-described methods for displaying notice information.

One of ordinary skill in the art will understand that the above described modules/units can each be implemented by hardware, or software, a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for an electronic device to display notice information, comprising:
receiving notice information sent from an application program, the received notice information including one or more operation elements provided by the application program; and
displaying, on a display of the electronic device, the received notice information in a predetermined area, the predetermined area being at least one of an area displaying a status bar or an area adjacent to the status bar, the status bar being arranged along an edge of the display.

2. The method according to claim 1, further comprising:
receiving operation information generated when an operation element displayed in the received notice information is operated; and
sending the operation information to the application program to process, wherein the application program implements a process according to the operation information.

3. The method according to claim 2, further comprising:
deleting the displayed notice information after receiving the operation information generated.

4. The method according to claim 1, further comprising:
receiving an unfolding instruction generated when an unfolding operation on the displayed notice information is performed; and
displaying the unfolded notice information after receiving the unfolding instruction.

5. The method according to claim 1, further comprising:
receiving a hiding instruction, the hiding instruction being generated when an operating position is not located in the predetermined area; and
hiding the displayed notice information.

6. The method according to claim 1, wherein when the predetermined area is the area displaying the status bar, the displaying of the received notice information in the predetermined area comprises:
determining a notice level corresponding to the received notice information, the notice level indicating a rank of importance of the received notice information;
determining a display height of the received notice information according to at least one of content or the notice level of the received notice information;
extending a display height of the status bar according to the display height of the received notice information; and
displaying the received notice information in the status bar with the extended display height.

7. The method according to claim 1, wherein when the predetermined area includes at least one display page, the displaying of the received notice information in the predetermined area comprises:
determining whether a number of pieces of notice information that are already displayed on a current display page in the predetermined area is less than a predetermined number, the predetermined number being a maximum number of pieces of notice information that can be displayed on the current display page;
if it is determined that the number of pieces of notice information that are already displayed on the current display page is less than the predetermined number, displaying the received notice information on the current display page; and
if it is determined that the number of pieces of notice information that are already displayed on the current display page is not less than the predetermined number, rearranging a position of a piece of notice information having a longest display time on the current display page to display the received notice information.

8. The method according to claim 7, further comprising:
receiving a page turning signal that instructs a page turning of the current display page in the predetermined area; and
turning the current display page to another display page corresponding to the page turning signal.

9. The method according to claim 8, wherein the turning of the current display page comprises:
when the page turning signal instructs to turn the current display page in the predetermined area to a next display page and the next display page exists, turning the current display page in the predetermined area to the next display page; and
when the page turning signal instructs to turn the current display page in the predetermined area to a previous display page and the previous display page exists, turning the current display page in the predetermined area to the previous display page.

10. An electronic device, comprising:
a processor;
a display; and
a memory for storing instructions executable by the processor;
wherein the processor is configured to:
receive notice information sent from an application program, the received notice information including one or more operation elements provided by the application program; and
display the received notice information in a predetermined area, the predetermined area being at least one of an area displaying a status bar or an area adjacent to the status bar, the status bar being arranged along an edge of the display.

11. The device according to claim 10, wherein the processor is further configured to:
receive operation information generated when an operation element displayed in the received notice information is operated; and
send the operation information to the application program to process, wherein the application program implements a process according to the operation information.

12. The device according to claim 11, wherein the processor is further configured to:
delete the displayed notice information after receiving the operation information.

13. The device according to claim 10, wherein the processor is further configured to:
receive an unfolding instruction generated when an unfolding operation on the displayed notice information is performed; and
display the unfolded notice information after receiving the unfolding instruction.

14. The device according to claim 10, wherein the processor is further configured to:
receive a hiding instruction, the hiding instruction being generated when an operating position is not located in the predetermined area; and
hide the displayed notice information.

15. The device according to claim 10, wherein when the predetermined area is the area displaying the status bar, the processor is further configured to:
determine a notice level corresponding to the received notice information, the notice level indicating a rank of importance of the received notice information;
determine a display height of the received notice information according to at least one of content or the notice level of the notice information;
extend a display height of the status bar according to the display height of the received notice information; and
display the notice information in the status bar with the extended display height.

16. The device according to claim 10, wherein when the predetermined area includes at least one display page, the processor is further configured to:
determine whether a number of pieces of notice information that are already displayed on a current display page in the predetermined area is less than a predetermined number, the predetermined number being a maximum number of pieces of notice information that can be displayed on the current display page;
if it is determined that the number of pieces of notice information that are already displayed on the current display page is less than the predetermined number, display the received notice information on the current display page; and
if it is determined that the number of pieces of notice information that are already displayed on the current display page is not less than the predetermined number, rearrange a position of a piece of notice information having a longest display time on the current display page to display the received notice information.

17. The device according to claim 16, wherein the processor is further configured to:
receive a page turning signal that instructs a page turning of the current display page in the predetermined area; and
turn the current display page to another display page corresponding to the page turning signal.

18. The device according to claim 17, wherein the processor is further configured to:
when the page turning signal instructs to turn the current display page in the predetermined area to a next display page and the next display page exists, turn the current display page in the predetermined area to the next display page; and
when the page turning signal instructs to turn the current display page in the predetermined area to a previous display page and the previous display page exists, turn the current display page in the predetermined area to the previous display page.

19. A non-transitory storage medium having stored therein instructions that, when executed by a processor of an electronic device, cause the electronic device to perform a method for displaying notice information, the method comprising:
receiving notice information sent from an application program, the received notice information including one or more operation elements provided by the application program; and
displaying, on a display of the electronic device, the received notice information in a predetermined area, the predetermined area being at least one of an area displaying a status bar or an area adjacent to the status bar, the status bar being arranged along an edge of the display.
